(19) United States
(12) Patent Application Publication
(10) Pub. No.: US 2026/0030538 A1
(43) Pub. Date: Jan. 29, 2026

(54) SYSTEMS AND METHODS FOR QUANTUM-ASSISTED MIXED INTEGER PROBLEM SOLVING

(71) Applicant: D-WAVE SYSTEMS INC., Burnaby (CA)

(72) Inventors: Mohsen Rahmani, Portland, OR (US); Marcus G. Daniels, El Cerrito, CA (US)

(21) Appl. No.: 18/634,159

(22) Filed: Apr. 12, 2024

Related U.S. Application Data
(60) Provisional application No. 63/462,356, filed on Apr. 27, 2023.

(51) Int. Cl. G06N 10/80; G06N 10/60

(52) U.S. Cl. CPC G06N 10/80; G06N 10/60

(57) ABSTRACT

There is provided a system and methods to determine an improved solution to a Mixed Integer Problem (MIP) using a quantum-assisted MIP solver. The methods are performed by a digital processor in communication with a quantum processor. Methods include: selecting at least one feasible solution determined by an MIP solver, determining a first sub-problem of the MIP based on the at least one feasible solution; casting the first sub-problem as Binary Quadratic Models (BQMs); solving the BQMs using the quantum processor to generate sample solutions; determining a second sub-problem based on at least the sample solutions, and obtaining a current solution to the MIP by evaluating the second sub-problem; and updating an incumbent solution if the current solution improves over the current incumbent solution. The quantum-assisted MIP solver uses hybrid crossover and mutation heuristics to improve the convergence time and accuracy of solutions obtained using Branch-and-Cut solvers.

### FIELD

This disclosure generally relates to systems and methods for quantum-assisted mixed integer problem solving, and, more specifically, to systems and methods for quantum-assisted heuristics in mixed integer problem solving.

### BACKGROUND

### Quantum Devices

Quantum devices are structures in which quantum mechanical effects are observable. Quantum devices include circuits in which current transport is dominated by quantum mechanical effects. Such devices include spintronics, and superconducting circuits. Both spin and superconductivity are quantum mechanical phenomena. Quantum devices can be used for measurement instruments, in computing machinery, and the like.

### Quantum Computation

A quantum computer is a system that makes direct use of at least one quantum-mechanical phenomenon, such as, superposition, tunneling, and entanglement, to perform operations on data. The elements of a quantum computer are qubits. Quantum computers can provide speedup for certain classes of computational problems such as computational problems simulating quantum physics.

### Superconducting Qubits

Superconducting qubits are solid state qubits based on circuits of superconducting materials. Operation of superconducting qubits is based on the underlying principles of magnetic flux quantization, and Josephson tunneling. Superconducting effects can be present in different configurations, and can give rise to different types of superconducting qubits including flux, phase, charge, and hybrid qubits. The different configurations can vary in the topology of the loops, the placement of the Josephson junctions, and the physical parameters of elements of the superconducting circuits, such as inductance, capacitance, and Josephson junction critical current.

### Quantum Processor

A quantum processor may take the form of a superconducting quantum processor. A superconducting quantum processor may include a number of superconducting qubits and associated local bias devices. A superconducting quantum processor may also include couplers (also known as coupling devices) that selectively provide communicative coupling between qubits.

In one implementation, the superconducting qubit includes a superconducting loop interrupted by a Josephson junction. The ratio of the inductance of the Josephson junction to the geometric inductance of the superconducting loop can be expressed as 2πLI_{C}/Φ₀ (where L is the geometric inductance, I_{C} is the critical current of the Josephson junction, and do is the flux quantum). The inductance and the critical current can be selected, adjusted, or tuned, to increase the ratio of the inductance of the Josephson junction to the geometric inductance of the superconducting loop, and to cause the qubit to be operable as a bistable device. In some implementations, the ratio of the inductance of the Josephson junction to the geometric inductance of the superconducting loop of a qubit is approximately equal to three.

In one implementation, the superconducting coupler includes a superconducting loop interrupted by a Josephson junction. The inductance and the critical current can be selected, adjusted, or tuned, to decrease the ratio of the inductance of the Josephson junction to the geometric inductance of the superconducting loop, and to cause the coupler to be operable as a monostable device. In some implementations, the ratio of the inductance of the Josephson junction to the geometric inductance of the superconducting loop of a coupler is approximately equal to, or less than, one.

Further details and embodiments of example quantum processors that may be used in conjunction with the present systems and devices are described in, for example, U.S. Pat. Nos. 7,533,068; 8,008,942; 8,195,596; 8,190,548; and, 8,421,053.

### Adiabatic Quantum Computation

A Hamiltonian is an operator whose eigenvalues are the allowed energies of the system. Adiabatic quantum computation can include evolving a system from an initial Hamiltonian to a final Hamiltonian by a gradual change. One example of adiabatic evolution is a linear interpolation between the initial Hamiltonian Hᵢ and the final Hamiltonian H_{f}, as follows:

$${H}_{e} = ( 1 - s ) {H}_{i} + {sH}_{f}$$

where Hₑ is the evolution, or instantaneous, Hamiltonian, and s is an evolution coefficient that can control the rate of evolution.

As the system evolves, the evolution coefficient s changes value from 0 to 1. At the start, the evolution Hamiltonian Hₑ is equal to the initial Hamiltonian Hᵢ, and, at the end, the evolution Hamiltonian Hₑ is equal to the final Hamiltonian H_{f}.

The system is typically initialized in a ground state of the initial Hamiltonian Hᵢ, and the goal of the adiabatic evolution is to evolve the system such that it ends up in a ground state of the final Hamiltonian H_{f} at the end of the evolution. If the evolution is too fast, then the system can transition to a higher energy state of the system, such as the first excited state.

The process of changing the Hamiltonian in adiabatic quantum computing may be referred to as evolution. An adiabatic evolution is an evolution that satisfies an adiabatic condition such as:

$$\dot{s} \vert 〈 1 \vert {dH}_{e} / ds \vert 0 〉 \vert = δ {g}^{2} ( s )$$

where \dot{s} is the time derivative of s, g(s) is the difference in energy between the ground state and first excited state of the system (also referred to herein as the gap size) as a function of s, and δ is a coefficient and δ<<1.

If the rate of change (for example, s), is slow enough that the system is always in the instantaneous ground state of the evolution Hamiltonian, then transitions at anti-crossings (i.e., when the gap size is smallest) are avoided. Equation (4) above is an example of a linear evolution schedule. Other evolution schedules can be used, including non-linear, parametric, and the like. Further details on adiabatic quantum computing systems, methods, and apparatus are described in, for example, U.S. Pat. Nos. 7,135,701 and 7,418,283.

### Quantum Annealing

Quantum annealing is a computational method that may be used to find a low-energy state of a system, typically preferably the ground state of the system. Similar in concept to classical simulated annealing, the method relies on the underlying principle that natural systems tend towards lower energy states because lower energy states are more stable. While classical annealing uses classical thermal fluctuations to guide a system to a low-energy state, quantum annealing may use quantum effects, such as quantum tunneling, as a source of delocalization to reach an energy minimum more accurately and/or more quickly than classical annealing.

A quantum processor may be designed to perform quantum annealing and/or adiabatic quantum computation. An evolution Hamiltonian can be constructed that is proportional to the sum of a first term proportional to a problem Hamiltonian and a second term proportional to a delocalization Hamiltonian, as follows:

$${H}_{E} ∝ A ( t ) {H}_{P} + B ( t ) {H}_{D}$$

where H_{E} is the evolution Hamiltonian, H_{P} is the problem Hamiltonian, H_{D} is the delocalization Hamiltonian, and A(t), B(t) are coefficients that can control the rate of evolution, and typically lie in the range [0,1].

In some implementations, a time varying envelope function can be placed on the problem Hamiltonian. A suitable delocalization Hamiltonian is given by:

$${H}_{D} ∝ - \frac{1}{2} {\sum }_{i = 1}^{N} {Δ}_{i} {σ}_{i}^{x}$$

where N represents the number of qubits,

$${σ}_{i}^{x}$$

and Δᵢ is the single qubit tunnel splitting induced in the i^{th} qubit. Here, the

$${σ}_{i}^{x}$$

terms are examples of “off-diagonal” terms.

A common problem Hamiltonian includes a first component proportional to diagonal single qubit terms and a second component proportional to diagonal multi-qubit terms, and may be of the following form:

$${H}_{P} ∝ - \frac{ε}{2} [ {\sum }_{i = 1}^{N} {h}_{i} {σ}_{i}^{z} + {\sum }_{j > i}^{N} {J}_{ij} {σ}_{i}^{z} {σ}_{j}^{z} ]$$

where N represents the number of qubits,

$${σ}_{i}^{z}$$

is the Pauli z-matrix for the i^{th} qubit, hᵢ and Jᵢⱼ are dimensionless local fields for the qubits, and couplings between qubits, and ε is some characteristic energy scale for H_{P}.

Here, the

$${σ}_{i}^{z} and {σ}_{i}^{z} {σ}_{j}^{z}$$

terms are examples of “diagonal” terms. The former is a single qubit term and the latter a two qubit term.

Throughout this specification, the terms “problem Hamiltonian” and “final Hamiltonian” are used interchangeably unless the context dictates otherwise. Certain states of the quantum processor are, energetically preferred, or simply preferred by the problem Hamiltonian. These include the ground states but may include excited states.

Hamiltonians such as H_{D} and H_{P} in the above two equations, respectively, may be physically realized in a variety of different ways. A particular example is realized by an implementation of superconducting qubits.

### Sampling

Throughout this specification and the appended claims, the terms “sample”, “sampling”, “sampling device”, and “sample generator” are used. These terms are used herein in like manner to their corresponding uses in the arts of statistics and statistical analysis, and electrical engineering.

In statistics, a sample is a subset of a population, i.e., a selection of data taken from a statistical population. Sampling is the process of taking the sample, and typically follows a defined procedure. For example, in a population, database, or collection of objects, a sample may refer to an individual datum, data point, object, or subset of data, data points, and/or objects.

In electrical engineering and related disciplines, sampling relates to taking a set of measurements of an analog signal or some other physical system. Sampling may include conversion of a continuous signal to a discrete signal.

In many fields, including simulations of physical systems, and computing, especially analog computing, the foregoing meanings may merge. For example, a hybrid computer can draw samples from an analog computer. The analog computer, as a provider of samples, is an example of a sample generator. The analog computer can be operated to provide samples from a selected probability distribution, the probability distribution assigning a respective probability of being sampled to each data point in the population.

An analog processor, for example a quantum processor and in particular a quantum processor designed to perform quantum annealing and/or adiabatic quantum computation, may be operated as a sample generator. The population can correspond to all possible states of the processor, and each sample can correspond to a respective state of the processor. Using an analog processor as a sample generator may be a preferred mode of operating the processor for certain applications. Operating an analog processor as a sample generator may also enable a broader range of problems to be solved compared to, for example, using an analog processor to find a low energy state of a Hamiltonian that encodes an optimization problem.

The foregoing examples of the related art and limitations related thereto are intended to be illustrative and not exclusive. Other limitations of the related art will become apparent to those of skill in the art upon a reading of the specification and a study of the drawings.

### BRIEF SUMMARY

Many practical optimization problems are mixed integer problems (MIPs), which are defined over more than one of: binary variables, integer variables, and continuous variables. Exact classical solvers, such as Branch-and-Bound and Branch-and-Cut solvers, can be used to determine solutions to MIPs, but may be slow due to an amount of time used to solve a plurality of linear programming problems and/or quadratic constraint problems. While use of quantum processors can advantageously improve solver performance, quantum solvers alone cannot certify optimality of a determined solution and are not natively suited to representing continuous variables.

To determine a precise, optimal solution to an MIP with a reduced computational time and cost, it may be advantageous to provide a hybrid classical and quantum MIP solver. A classical Branch-and-Cut solver can be augmented with quantum-assisted heuristics, such as a quantum-assisted crossover or quantum-assisted mutation heuristic. These heuristics can be used to further reduce a search space of the solution to the MIP in part through two passes of generation of a discretized and reduced representation of the MIP, both of which include inputs generated by and/or operations performed by each of a digital processor and a quantum processor.

In an aspect of the invention, there is provided a method to determine an improved solution to a Mixed Integer Problem (MIP) having an objective function that is performed by at least one digital processor in communication with at least one quantum processor. The method includes: selecting, by the at least one digital processor, at least one feasible solution determined by an MIP solver; determining, by the at least one digital processor, a first sub-problem of the MIP based on the at least one feasible solution, wherein the first sub-problem is a linear binary sub-problem; casting, by the at least one digital processor, the first sub-problem as one or more Binary Quadratic Models (BQMs); embedding a topological representation of the one or more BQMs onto the at least one quantum processor; causing, by the at least one digital processor, the at least one quantum processor to generate a plurality of sample solutions to the one or more BQMs; receiving, from the at least one quantum processor, the plurality of sample solutions to the one or more BQMs; determining, by the at least one digital processor, a second sub-problem of the MIP based on at least the plurality of sample solutions to the one or more BQMs; evaluating, by the at least one digital processor, the second sub-problem of the MIP using the MIP solver to obtain a current solution to the MIP; and, updating an incumbent solution of the MIP to the current solution where an objective function value of the current solution is determined to be an improvement over an objective function value of a current incumbent solution.

In some implementations, the determining the first sub-problem of the MIP based on the at least one feasible solution can include: fixing one or more first variables of the MIP, the one or more first variables of the MIP including one or more of: at least one binary variable and at least one integer variable. The determining, by the at least one digital processor, the second sub-problem of the MIP based on at least the plurality of sample solutions to the one or more BQMs can include: fixing one or more second variables of the MIP, wherein the one or more second variables are one or more binary variables having a same value across all sample solutions in the plurality of sample solutions to the one or more BQMs.

In some implementations, prior to the selecting, by the at least one digital processor, the at least one feasible solution determined by the MIP solver, the method can include: receiving, by the at least one digital processor, the objective function of the MIP; and, initializing one or more constraints of an optimal solution to the MIP.

In some implementations, prior to the selecting, by the at least one digital processor, at least one feasible solution determined by an MIP solver, the method can include: iterating a Branch-and-Cut solver as the MIP solver over at least a portion of a problem state space to determine the at least one feasible solution.

In some implementations, the selecting, by the at least one digital processor, at least one feasible solution determined by the MIP solver can include: selecting two or more feasible solutions determined by the MIP solver. The determining a first sub-problem of the MIP based on the at least one feasible solution can include: fixing a first subset of problem variables of the MIP, and the first subset of problem variables of the MIP can include at least one of binary variables and integer variables having a same value in all of the two or more feasible solutions.

In some implementations, the determining a first sub-problem of the MIP based on the at least one feasible solution can further include: determining values of one or more of: at least one continuous variable and at least one slack variable in each of the two or more feasible solutions; converting inequality constraints to equality constraints to fix the values of the one or more of: at least one continuous variable and at least one slack variable; and, converting the integer variables to binary variables.

In some implementations, the selecting, by the at least one digital processor, at least one feasible solution determined by the MIP solver can include: selecting one feasible solution determined by the MIP solver. The determining a first sub-problem of the MIP based on the at least one feasible solution can include: fixing a random subset of problem variables of the MIP, and the random subset of problem variables of the MIP including one or more of: at least one integer variable and at least one binary variable.

In some implementations, the embedding a topological representation of the one or more BQMs onto the at least one quantum processor can include: mapping the one or more BQMs to the topological representation of the one or more BQMs to represent the first sub-problem of the MIP based on relationships between variables of the one or more BQMs; mapping the topological representation of the one or more BQMs to a hardware graph corresponding to a topology of the at least one quantum processor; and, embedding the first sub-problem of the MIP onto the at least one quantum processor in accordance with the hardware graph.

In some implementations, the at least one quantum processor can include a plurality of qubits. The causing the at least one quantum processor to generate the plurality of sample solutions to solve the one or more BQMs can further include: evolving, for predetermined or otherwise specified number of times, the plurality of qubits in the quantum processor having the topological representation of the one or more BQMs embedded thereon. Each sample solution of the plurality of sample solutions can be characterized by states of the plurality of qubits after a respective evolution of the quantum processor.

In some implementations, the determining, by the at least one digital processor, a first sub-problem of the MIP based on the at least one feasible solution can include performing operations of a crossover heuristic or performing operations of a mutation heuristic.

In an aspect of the invention, there is provided a system to determine an improved solution to a Mixed Integer Problem (MIP) having an objective function. The system can include: at least one non-transitory processor-readable media that stores at least one of processor-executable instructions or data; and at least one digital processor communicatively coupled to the least one non-transitory processor-readable media and to at least one quantum processor. In response to execution of the at least one of processor-executable instructions or data, the at least one digital processor: selects at least one feasible solution determined at least in part by an MIP solver; determines a first sub-problem of the MIP based on the at least one feasible solution, wherein the first sub-problem is a linear binary sub-problem; casts the first sub-problem as one or more Binary Quadratic Models (BQMs); embeds a topological representation of the one or more BQMs onto the at least one quantum processor; causes the at least one quantum processor to generate a plurality of sample solutions to the one or more BQMs; receives, from the at least one quantum processor, the plurality of sample solutions to the one or more BQMs; determines a second sub-problem of the MIP based on at least the plurality of sample solutions to the one or more BQMs; evaluates the second sub-problem of the MIP using the MIP solver to obtain a current solution to the MIP; and, updates an incumbent solution of the MIP to the current solution when an objective function value of the current solution is determined to be an improvement over an objective function value of a current incumbent solution.

In some implementations, the at least one digital processor: fixes one or more first variables of the MIP in order to determine the first sub-problem of the MIP based on the at least one feasible solution, and the one or more first variables of the MIP include one or more of: at least one binary variable and at least one integer variable; and, fixes one or more second variables of the MIP in order to determine the second sub-problem based on at least the plurality of sample solutions, and the one or more second variables are one or more binary variables having a same value across all sample solutions in the plurality of sample solutions to the one or more BQMs.

In some implementations, the MIP solver is a branch-and-cut solver or a branch-and-bound solver, and the at least one digital processor iterates the MIP solver over at least a portion of a problem state space to determine the at least one feasible solution.

In some implementations, the at least one digital processor and the at least one quantum processor perform a quantum-assisted heuristic to determine the improved solution to the MIP.

In some implementations, the quantum-assisted heuristic is a quantum-assisted crossover heuristic or a quantum-assisted mutation heuristic.

In some implementations, the at least one quantum processor can include a plurality of superconducting qubits.

In some implementations, each sample solution of the plurality of sample solutions to the one or more BQMs is a set of states of the plurality of qubits obtained through a respective evolution of the plurality of qubits of the at least one quantum processor.

In some implementations, the quantum processor is a quantum annealing processor or an adiabatic quantum processor.

In some implementations, the at least one digital processor: selects two or more feasible solutions determined by the MIP solver; and, fixes a first subset of problem variables of the MIP. The first subset of problem variables of the MIP can include one or more binary variables and one or more integer variables having a same value in all of the two or more feasible solutions.

In some implementations, the at least one digital processor: selects one feasible solution determined by the MIP solver; and fixes a random subset of problem variables of the MIP including one or more of: at least one integer variable and at least one binary variable.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn, are not necessarily intended to convey any information regarding the actual shape of the particular elements, and may have been solely selected for ease of recognition in the drawings.

FIG. 1 is a schematic diagram of an example hybrid computing system, in accordance with the presently described systems, devices, articles, and methods

FIG. 2 is a schematic diagram of a circuit of an example superconducting quantum processor, in accordance with the presently described systems, devices, articles, and methods.

FIG. 3 is a schematic diagram of an example system to implement a hybrid mixed integer problem solver, in accordance with the presently described systems, devices, articles, and methods.

FIG. 4 is a schematic diagram that illustrates a hybrid mixed integer problem solver, in accordance with the presently described systems, devices, articles, and methods.

FIG. 5 is a flowchart that illustrates a method to determine a linear binary sub-problem using a quantum-assisted cross-over heuristic, in accordance with the presently described systems, devices, articles, and methods.

FIG. 6 is a flowchart that illustrates a method to determine a linear binary sub-problem using a quantum-assisted mutation heuristic, in accordance with the presently described systems, devices, articles, and methods.

FIG. 7 is a flowchart that illustrates a method to determine an improved solution to a Mixed Integer Problem, in accordance with the presently described systems, devices, articles, and methods.

### DETAILED DESCRIPTION

### Preamble

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures associated with computer systems, server computers, and/or communications networks have not been shown or described in detail to avoid unnecessarily obscuring descriptions of the implementations.

Unless the context requires otherwise, throughout the specification and claims that follow, the word “comprising” is synonymous with “including,” and is inclusive or open-ended (i.e., does not exclude additional, unrecited elements or method acts).

Reference throughout this specification to “one implementation” or “an implementation” means that a particular feature, structure or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics may be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

The headings and Abstract of the Disclosure provided herein are for convenience only and do not interpret the scope or meaning of the implementations.

### Example Hybrid Computing System

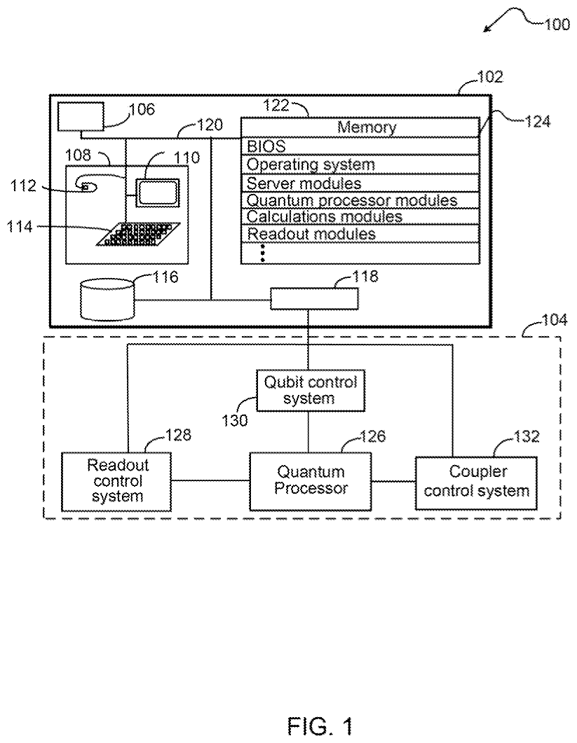

FIG. 1 illustrates a computing system 100 comprising a digital computer 102. The example digital computer 102 includes digital processor(s) 106 that may be used to perform classical digital processing tasks. Digital computer 102 may further include at least one system memory 122, and at least one system bus 120 that couples various system components, including coupling system memory 122 to digital processor(s) 106. System memory 122 may store one or more sets of processor-executable instructions, which may be referred to as modules 124.

The digital processor(s) 106 may be any logic processing unit or circuitry (for example, integrated circuits), such as one or more central processing units (“CPUs”), graphics processing units (“GPUs”), digital signal processors (“DSPs”), application-specific integrated circuits (“ASICs”), programmable gate arrays (“FPGAs”), programmable logic controllers (“PLCs”), etc., and/or combinations of the same.

In some implementations, computing system 100 comprises an quantum computer 104, which may include one or more quantum processors 126. Quantum processor 126 may include at least one superconducting integrated circuit. Digital computer 102 may communicate with quantum computer 104 via, for instance, a controller 118. Certain computations may be performed by quantum computer 104 at the instruction of digital computer 102, such as those described in greater detail herein.

Digital computer 102 may include a user input/output subsystem 108. In some implementations, user input/output subsystem 108 includes one or more user input/output components such as a display 110, a mouse 112, and/or a keyboard 114.

System bus 120 may employ any known bus structures or architectures, including a memory bus with a memory controller, a peripheral bus, and a local bus. System memory 122 may include non-volatile memory, such as read-only memory (“ROM”), static random access memory (“SRAM”), Flash NAND; and volatile memory such as random-access memory (“RAM”).

Digital computer 102 may also include other non-transitory computer- or processor-readable storage media or a non-volatile memory 116. Non-volatile memory 116 may take a variety of forms, including: a hard disk drive for reading from and writing to a hard disk (for example, a magnetic disk), an optical disk drive for reading from and writing to removable optical disks, and/or a solid state drive (SSD) for reading from and writing to solid state media (for example NAND-based Flash memory). Non-volatile memory 116 may communicate with digital processor(s) 106 via system bus 120 and may include appropriate interfaces or controllers, such as controller 118, coupled to system bus 120. Non-volatile memory 116 may serve as long-term storage for processor- or computer-readable instructions, data structures, or other data (sometimes called program modules or modules 124) for digital computer 102.

Although digital computer 102 has been described as employing hard disks, optical disks and/or solid-state storage media, those skilled in the relevant art will appreciate that other types of non-transitory and non-volatile computer-readable media may be employed. Those skilled in the relevant art will appreciate that some computer architectures employ non-transitory volatile memory and non-transitory non-volatile memory. For example, data in volatile memory may be cached to non-volatile memory or a solid-state disk that employs integrated circuits to provide non-volatile memory.

Various processor- or computer-readable and/or executable instructions, data structures, or other data may be stored in system memory 122. For example, system memory 122 may store instructions for communicating with remote clients and scheduling use of resources including resources on digital computer 102 and quantum computer 104. Also, for example, system memory 122 may store at least one of processor executable instructions or data that, when executed by at least one processor, causes the at least one processor to execute the various algorithms to execute instructions. In some implementations, system memory 122 may store processor- or computer-readable calculation instructions and/or data to perform pre-processing, co-processing, and post-processing at least partially using quantum computer 104. System memory 122 may store a set of quantum computer interface instructions to interact with quantum computer 104. For example, system memory 122 may store processor- or computer-readable instructions, data structures, or other data which, when executed by a processor or computer causes the processor(s) or computer(s) to execute one, more or all of the acts of the methods described herein.

Quantum computer 104 may include at least one quantum processor, such as quantum processor 126. Quantum computer 104 may be provided in an isolated environment, for example, in an isolated environment that shields the internal elements of the quantum computer from heat, magnetic field, and other external noise. The isolated environment may include a refrigerator, for instance a dilution refrigerator, operable to cryogenically cool the analog processor, for example to temperature below approximately 1 K.

Quantum computer 104 may include programmable elements such as qubits, couplers, and other devices (also referred to herein as: “on-chip superconductive controllable devices”). Qubits may be read out via a readout control system 128. Readout results may be sent to other computer- or processor-readable instructions of digital computer 102. Qubits may be controlled via a qubit control system 130. Qubit control system 130 may include on-chip Digital to Analog Converters (DACs) and analog lines that are operable to apply a bias to a target device. Couplers that couple qubits may be controlled via a coupler control system 132. Coupler control system 132 may include elements operable to tune a target device, such as on-chip DACs and analog lines.

Quantum computer 104, including one or more of: quantum processor 126, readout control system 128, qubit control system 130, and coupler control system 132, comprises at least one material that exhibits superconductive behavior at and below a critical temperature.

In some implementations, qubit control system 130 and coupler control system 132 may be used to implement a quantum annealing schedule as described herein on quantum computer 104 employing one or more analog processors. In accordance with some implementations of the present disclosure, a quantum processor, such as quantum processor 126, may be operable to perform quantum annealing and/or adiabatic quantum computation. Examples of quantum processors are described in U.S. Pat. No. 7,533,068.

Alternatively, a quantum processor, such as quantum processor 126, may be a universal quantum computer, and may be designed to perform universal adiabatic quantum computing, or other forms of quantum computation such as gate model-based quantum computation.

### Example Superconducting Quantum Processor

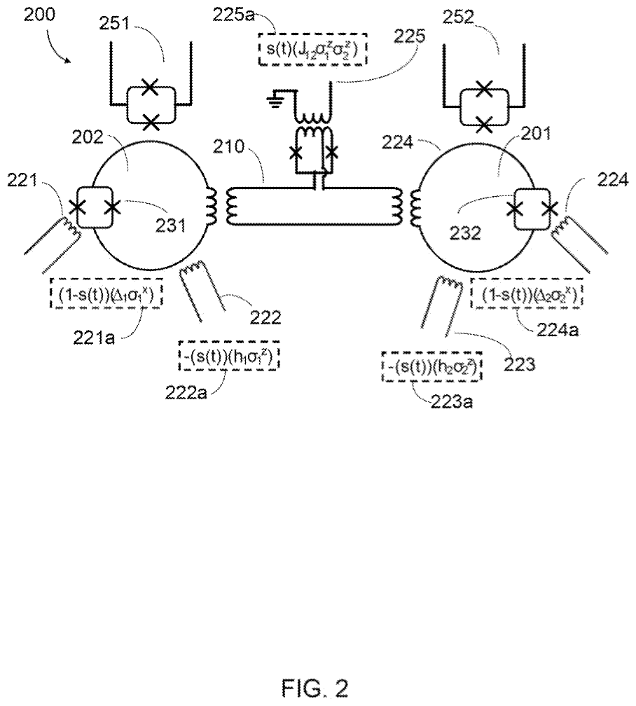

FIG. 2 illustrates a circuit 200 of an example portion of a superconducting quantum processor, according to at least one implementation. The superconducting quantum processor to which circuit 200 belongs may be, for example, a portion of quantum computer 104 that is included as part of computing system 100 of FIG. 1. This superconducting quantum processor may be used, for instance, to perform quantum annealing and/or adiabatic quantum computing.

Circuit 200 includes two qubits 201 and 202. Also shown is a tunable coupling (diagonal coupling) provided by a coupler 210 between qubits 201 and 202 (i.e., providing 2-local interaction). While circuit 200 shown in FIG. 2 includes only two qubits 201, 202 and one coupler 210, those of skill in the art will appreciate that a superconducting quantum processor may include any number of qubits and any number of couplers coupling information between them.

Circuit 200 includes a plurality of interfaces 221, 222, 223, 224, 225 that are used to configure and control the state of the superconducting quantum processor. Each interface of plurality of interfaces of interfaces 221-225 can be realized by a respective inductive coupling structure, as illustrated, as part of a programming subsystem and/or an evolution subsystem. Alternatively, or in addition, plurality of interfaces 221-225 may be realized by a galvanic coupling structure. In some implementations, one or more interfaces of plurality of interfaces 221-225 may be driven by one or more flux storage devices or DACs. Such a programming subsystem and/or evolution subsystem may be separate from the superconducting quantum processor, or may be included locally (i.e., on-chip with the superconducting quantum processor). For example, referring to computing system 100 of FIG. 1, a locally included programming subsystem and/or optional evolution subsystem can be arranged as part of quantum computer 104.

In the operation of the superconducting quantum processor, interfaces 221 and 224 may each be used to couple a flux signal into a respective compound Josephson junction (CJJ) 231 and 232, respectively, of qubits 201 and 202, thereby realizing a tunable tunneling term (the Δᵢ term) in a system Hamiltonian. This coupling provides the off-diagonal σ^{x} terms of the Hamiltonian and these flux signals are examples of “delocalization signals”. Examples of Hamiltonians (and their terms) used in quantum computing are described in greater detail, for example, in U.S. Pat. No. 9,424,526.

Similarly, interfaces 222 and 223 may each be used to apply a flux signal into a respective qubit loop of qubits 201 and 202, thereby realizing the hᵢ terms (dimensionless local fields for the qubits) in the system Hamiltonian. This coupling provides the diagonal σ^{z} terms in the system Hamiltonian. Furthermore, interface 225 may be used to couple a flux signal into coupler 210, thereby realizing the Jᵢⱼ term(s) (dimensionless local fields for the couplers) in the system Hamiltonian.

$${σ}_{i}^{z} {σ}_{j}^{z}$$

In FIG. 2, the contribution of each interface of plurality of interfaces 221, 222, 223, 224, and 225 to the system Hamiltonian is indicated in broken line boxes 221a, 222a, 223a, 224a, 225a, respectively. As shown, in the example of FIG. 2, broken line boxes 221a-225a are elements of time-varying Hamiltonians for quantum annealing and/or adiabatic quantum computing.

Throughout this specification and the appended claims, the term “quantum processor” is used to generally describe at least a collection of physical qubits (e.g., qubits 201 and 202) and qubit couplers (e.g., coupler 210). Corresponding parameters of the physical qubits and the qubit couplers (e.g., the qubit hᵢ values and the coupler Jᵢⱼ values) are referred to herein as the “controllable parameters” of the quantum processor.

In the context of a quantum processor, the term “programming subsystem” is used to generally describe the interfaces (e.g., “programming interfaces” 222, 223, and 225) used to apply the controllable parameters to at least qubits 201, 202 and coupler 210 of the superconducting quantum processor and other associated control circuitry. In some implementations, programming interfaces 222, 223, and 225 may be included as part of readout control system 128, qubit control system 130, and/or coupler control system 132 of FIG. 1. In some implementations, programming interfaces 222, 223, and 225 may include DACs, which can be used to control qubits, couplers, and parameter tuning devices.

The programming interfaces of the programming subsystem may communicate with other subsystems that may be separate from the quantum processor or may be included locally on the quantum processor. The programming subsystem may be configured to receive programming instructions in a machine language of the quantum processor and execute the programming instructions to program the programmable and controllable devices in accordance with the programming instructions.

Similarly, in the context of a quantum processor that performs annealing and/or adiabatic quantum computation, the term “evolution subsystem” generally includes the interfaces (e.g., “evolution interfaces” 221 and 224) used to evolve devices such as the qubits of circuit 200 and other associated control circuitry. For example, the evolution subsystem may include analog signal lines and their corresponding interfaces (221, 224) to the qubits (201, 202).

In some implementations, in which the quantum processor is implemented as quantum computer 104 of FIG. 1, qubits 201, 202 and coupler 210 may be arranged as part of quantum processor 126, and programming and evolution subsystems may include structures belonging to one or more of: readout control system 128, qubit control system 130, and coupler control system 132 of quantum computer 104. The initial programming instructions may be provided through digital computer 102 and sent to the quantum processor and its corresponding subsystems through digital processor(s) 106.

Circuit 200 also includes readout devices 251 and 252, in which readout device 251 is associated with qubit 201 and readout device 252 is associated with qubit 202. In the example implementation shown in FIG. 2, each of readout devices 251 and 252 includes a direct current superconducting quantum interference device (DC-SQUID) inductively coupled to the corresponding qubit. Readout devices 251, 252 can be implemented as described in one or more of: U.S. Pat. Nos. 6,627,916; 8,169,231; 10,938,346; and, 11,424,521 and/or US Patent Application Publication No. 2022/0207404, which are incorporated by reference herein. In the context of circuit 200, the term “readout subsystem” is used to generally describe the readout devices 251, 252 used to read out the final states of the qubits (e.g., qubits 201 and 202) in the superconducting quantum processor to produce a bit string. The readout subsystem may also include other elements, such as routing circuitry (e.g., latching elements, a shift register, or a multiplexer circuit) and/or may be arranged in alternative configurations (e.g., an XY-addressable array, an XYZ-addressable array, etc.), any of which may comprise DACs. Qubit readout may also be performed using alternative circuits, such as that described in U.S. Pat. No. 8,854,074. In some implementations, readout devices 251 and 252 and other elements of the readout subsystem in circuit 200 may form a portion of readout control system 128 of FIG. 1.

While FIG. 2 illustrates only two physical qubits (201, 202), one coupler (210), and two readout devices (251, 252), a quantum processor (e.g., processor comprising circuit 200) may employ any number of qubits, couplers, and/or readout devices, including a larger number (e.g., hundreds, thousands or more) of qubits, couplers and/or readout devices. The application of the teachings herein to processors with a different (e.g., larger) number of computational components should be readily apparent to those of ordinary skill in the art.

A superconducting quantum processor may include other types of qubits besides superconducting flux qubits. For example, a superconducting quantum processor may include superconducting charge qubits, transmon qubits, and the like.

### Mixed Integer Problem Solving

Optimization problems define many commercially and industrially relevant problems for which a target solution is a maximum or minimum value or set of values. Many optimization problems are defined over more than one type of variable. For instance, an optimization problem can include two or more of: binary variables, integer variables, and continuous variables. Such optimization problems can be referred to as “Mixed Integer Problems” (MIPs), in which values of at least some of the variables are constrained to integer values in the optimal solution. Feasible or desirable solutions to such MIPs may also limited by constraints on the values of the variables, such as equality constraints and/or inequality constraints, each of which may have linear terms and/or quadratic terms to represent relationships between the variables.

Practical applications of optimization problems often include finding solutions to MIPs, since problems facing many industries have inputs of more than one variable type.

Mixed integer optimization problems are prevalent in the financial industry, and may include: optimization for management of assets and liabilities; portfolio optimization; value-at-risk cash flow matching; and optimization of asset pricing and arbitrage. In finance-related MIPs: examples of a continuous variable may include a value of an asset over time, or a remaining value of a loan over time that accounts for payments made and interest accrued; an example of an integer variable may be a value of a fixed interest or return rate, or a number of shares held in a security; and, an example of a binary value may be an indication of whether a particular financial tool or investment is in use.

MIPs are also frequently found in the energy industry, such as: future energy modelling, including optimization of different energy sources, like batteries and renewable sources, within a specified time frame; optimization of gasoline distribution throughout a distribution network operation; optimization of routing, location placement, volume, and/or rate for energy transmission or energy generation expansion planning; and, optimization of energy distribution operations. Each of these applications may comprise: continuous variables, like an energy use or transmission rate with respect to time; integer variables, like a number of distribution lines available; and, binary variables, like an indication whether energy is to be transmitted to a particular terminal.

A specific example of an MIP in the energy industry is a hydroelectricity reservoir optimization problem, which has an objective to schedule hydroelectric turbines and pumps to maximize revenue from energy arbitrage and to meet a prescribed set of operational and physical constraints, such as elevation targets and maximum outflow. This example problem includes binary variables of at least on/off status of pumps and turbines, and includes continuous variables of at least energy sales and target water elevation.

Many MIPs can be solved using classical algorithms (i.e., algorithms that are implemented on a digital processor, such as digital processor(s) 106 of digital computer 102 in FIG. 1). Such classical algorithms include characteristics required for determining solutions to practical optimization problems, such as: the ability to model inequality constraints; the ability to prove optimality of a determined solution; determination of a high precision solution; possible use in both deterministic and opportunistic modelling; and, the ability to allow arbitrary connectivity between problem features. Using classical solvers, MIPs can be solved through linear or quadratic programming approaches.

In some implementations, an MIP can be solved using a classical Branch-and-Bound algorithm executed on a digital processor. The Branch-and-Bound solver is an exact solver that searches the complete space of solutions for a given problem for an exact optimal or optimized solution, or multiple optimal or optimized solutions where they exist. The Branch-and-Bound algorithm can include a systematic enumeration of candidate solutions by a search of a state space defined by the problem. The Branch-and-Bound algorithm searches parts of the solution space only implicitly, based on a determined bound combined with the value of the current candidate optimal solution. The algorithm describes the status of the solution with respect to the search of the solution space by a pool of a yet unexplored subset of the solution space and the best solution found so far. The unexplored spaces are represented as nodes in a dynamically generated search tree.

A Branch-and-Bound algorithm: selects nodes to explore in a search tree, which initially only contains the root; calculates a bounding function; and, branches the solution space. The leaves of the search tree correspond to all possible solutions starting from the root node. The bounding function is compared to the current best solution to determine if a subspace might contain the optimal solution, in which case the subspace is explored. Otherwise, the subspace is discarded. The bounding function has an upper bound of a feasible solution (i.e., a solution within a set of candidate solutions that satisfies all given constraints of the problem) and a lower bound of a solution to a relaxation of the sub-problem that defines the subspace. A Branch-and-Bound algorithm can return multiple optimal solutions where they exist. Further detail on the Branch-and-Bound algorithm can be found in Clausen (Jens Clausen, Branch and Bound Algorithms-Principles and Examples, Mar. 12, 1999).

However, the Branch-and-Bound algorithm is an exhaustive search, also referred to as: “brute-force” search, which can include systematically enumerating and testing all possible candidate solutions for optimality. As such, an amount of time required to determine an optimal solution may increase with a number of variables defined by the problem. In some cases, the time taken to return an optimal solution can become too large to be of practical use.

A variation on the Branch-and-Bound algorithm is the Branch-and-Cut algorithm. The Branch-and-Cut algorithm incorporates the use of cutting planes into the Branch-and-Bound algorithm to quickly limit a search space of solutions to the problem, as the generated cutting planes act as additional constraints.

Like the Branch-and-Bound algorithm, implementation of the Branch-and-Cut algorithm includes comparing a current best solution to a bounding function to determine if a subspace defined by a sub-problem might contain the optimal solution to the problem. The bounding function may have an upper limit of a non-integral feasible solution to relaxation of the sub-problem, and a lower limit of an integral solution to relaxation of the sub-problem. One or more cutting planes may be generated that are violated by a previously feasible solution, such that a feasible solution of relaxation of the sub-problem with the added constraint of the cutting plane yields a narrowed subspace to branch into in search of the optimal solution. Sub-problems having solutions exceeding the upper bound of the current solution are pruned, and their subspaces are not explored.

Unlike brute-force methods, such as the Branch-and-Bound algorithm, a systematic search approach can be used to find optimal solutions of MIPs instead of exploring all possible solution combinations. During execution of the method, the Branch-and-Cut solver builds a solution pool including all known feasible solutions. In some implementations, information about the optimal solution provided by the solution pool may be used in combination with one or more heuristic methods to find a solution closer to the optimal solution, resulting in faster convergence of the algorithm.

Even though a solver using a Branch-and-Cut algorithm (hereinafter also a “Branch-and-Cut solver”) may provide a solution more quickly than the Branch-and-Bound algorithm, the Branch-and-Cut solver is still susceptible to the overarching drawbacks of classical MIP solvers. For instance, determining a high-quality solution or proving optimality of a provided solution with the classical Branch-and-Cut solver may be slow for complex MIPs. Despite a reduced search space, determining solutions to a plurality of linear programming problems and/or quadratic constraint problems may be time consuming.

In some implementations, quantum processors can be used to solve combinatorial optimization problems, and may advantageously improve solver performance and increase computational speed in comparison to determining solutions to optimization problems using classical methods.

However, exclusive use of a quantum processor as a solver might not be suitable for solving MIPs. Some quantum processors, such as quantum annealers, operate probabilistically and cannot be used to certify that a determined solution is the optimal solution. As well, quantum processors on which a topological representation of problem variables and relationships therebetween are embedded into the hardware using physical qubits and couplers are well suited to represent binary and integer problem variables, while continuous variables are not natively representable. Consequently, MIPs are difficult to solve using a quantum processor alone.

In other implementations, a quantum processor can be used as a sample generator to solve an MIP for which all problem variables have been discretized. In such implementations, a representation of the problem can be programmed onto the quantum processor as a quadratic unconstrained binary optimization (QUBO) problem based on a binary quadradic model (BQM).

QUBO problems are commonly used in computer science, and include the variables: TRUE and FALSE, which have states that correspond to 1 and 0 values. A QUBO problem is defined using an upper-diagonal matrix Q, which is an N×N upper-triangular matrix of real weights, and x, a vector of binary variables, as minimizing the function:

$$f ( x ) = {\sum }_{i} {Q}_{i , i} {x}_{i} + {\sum }_{i < j} {Q}_{i , j} {x}_{i} {x}_{j} \qquad ( 1 )$$

where the diagonal terms Q_{i,i} are the linear coefficients and the nonzero off-diagonal terms are the quadratic coefficients Q_{i,j}. This can be expressed more concisely as

$${min}_{x ∈ {\{ 0 , 1 \}}^{n}} {x}^{T} Qx .$$

In scalar notation, an objective function of a problem to be solved can be expressed as a QUBO as follows:

$${E}_{qubo} ( {a}_{i} , {b}_{i , j} ; {q}_{i} ) = {\sum }_{i} {a}_{i} {q}_{i} + {\sum }_{i < j} {b}_{i , j} {q}_{i} {q}_{j} \qquad ( 2 )$$

Quadratic unconstrained binary optimization problems are unconstrained in that there are no constraints on the variables other than those expressed in Q.

To solve an MIP using a quantum processor to generate sample solutions to the QUBO, all of the continuous problem variables are first discretized. However, representing double precision continuous variables using the topology of a quantum processor is computationally expensive and requires a large number of qubits. As a result, directly solving MIPs in this manner limits the number of problem variables that can be supported, thus limiting the complexity of the problems that can be solved.

Therefore, it is advantageous to provide a hybrid classical and quantum MIP solver and a method of solving MIPs that is capable of determining a high precision solution and certifying the optimality of this solution, while reducing computational time and cost relative to classical solvers.

A hybrid MIP solver and method of solving MIPs can desirably combine the precision and reliability of a classical solver with the advantages realized by quantum computing techniques. A classical Branch-and-Cut solver can be augmented with quantum-assisted heuristics to further accelerate the determination of an optimal solution. As use of the Branch-and-Cut algorithm reduces a search space of the solution to an MIP, only a subset of the problem variables may be discretized, expressed as QUBOs, and embedded onto the quantum processor for generating candidate solutions.

### Mixed Integer Problem Solving Using Quantum-Assisted Heuristics

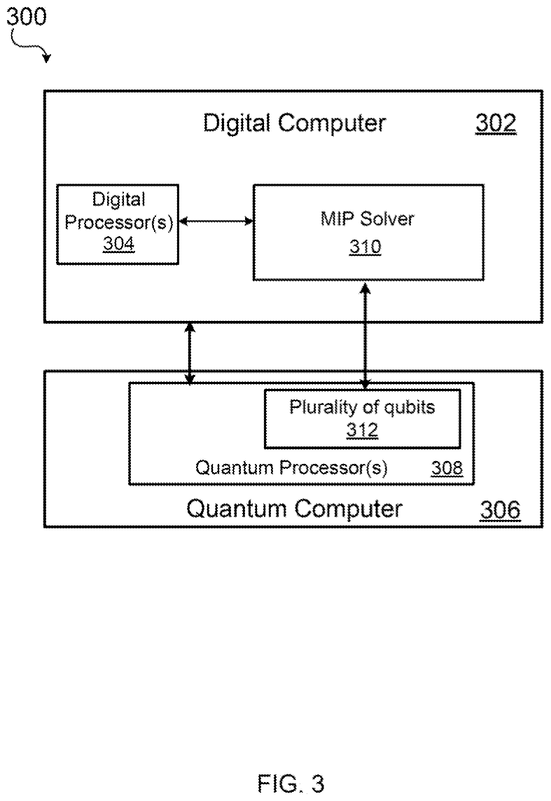

FIG. 3 illustrates an example system to implement a hybrid mixed integer problem (MIP) solver, in accordance with the presently described systems, devices, articles, and methods. A system 300 shown in FIG. 3 includes a digital computer 302 having at least one digital processor 304, which is communicatively coupled to a quantum computer 306 having at least one quantum processor 308.

In some implementations, system 300 may be part of a hybrid computing system such as computing system 100 in FIG. 1. In such an implementation, digital computer 302 and digital processor(s) 304 may be digital computer 102 and digital processor(s) 106, respectively. As well, quantum computer 306 and one or more quantum processors 308 may be quantum computer 104 and quantum processor 126, respectively.

Digital computer 302 includes digital processor(s) 304 and an MIP solver 310, which are arranged in communication with one another. In some implementations, at least a portion of MIP solver 310 can include stored computer-readable and/or processor-executable instructions, that, when executed by digital processor(s) 304, perform acts for determining a solution to a mixed integer problem as discussed in further detail below. In some implementations, MIP solver 310 can include a portion of the memory associated with digital computer 302, such as system memory 122, so that computer-readable and/or processor-executable instructions to execute the methods described herein (e.g., methods 500, 600, and 700) may be stored as part of MIP solver 310. Additionally, or alternatively, at least a portion of MIP solver 310 may include a dedicated digital processor or at least a portion of a digital processor that is dedicated to execution of instructions to solve MIPs.

Although digital processor(s) 304 is shown as part of digital computer 302 in FIG. 3, digital processor(s) 304 can alternatively be arranged external to, but in communication with, digital computer 302 (for example, as part of a different digital computer). In some implementations, more than one digital processor may be included as part of system 300, and at least one of digital processor(s) 304 may be arranged within digital computer 302 and one or more of these digital processors may be arranged external to digital computer 302 (for example, as part of one or more different digital computers). In such an implementation, each digital processor arranged external to digital computer 302 may be communicatively coupled to digital computer 302, which may be communicatively coupled to at least one of digital processor(s) 304 within digital computer 302 and/or MIP solver 310.

Although MIP solver 310 is shown as part of digital computer 302 in FIG. 3, MIP solver 310 can optionally be arranged in a distributed manner, such that all or a portion of MIP solver 310 is located external to digital computer 302. For example, a portion of MIP solver 310 may be processor-executable instructions stored on a cloud and accessed via digital processor(s) 304 of digital computer 302. In another implementation, digital computer 302 may include more than one physical computing systems, and may include components in different physical locations that are in communication with one another.

Quantum computer 306 is arranged in communication with digital computer 302. In some implementations, digital processor(s) 304 of digital computer 302 can provide instructions to quantum processor 308 that control the behavior of one or more components of quantum computer 306, such as plurality of qubits 312 or couplers in quantum processor 308. In some implementations, digital computer 302 may control one or more components of quantum processor 308 via additional control system circuitry in quantum computer 306, such as by qubit control system 130, coupler control system 132, and/or readout control system 128 of computing system 100. In some implementations, digital processor(s) 304 of digital computer 302 can instruct quantum processor 308 to perform computations, such as those described herein for determining a solution to an MIP using MIP solver 310.

Quantum processor 308 can be an analog processor that performs quantum annealing, adiabatic quantum computing, and/or gate model quantum computing. In some implementations, MIP solver 310 can include non-transitory computer-readable and/or processor-executable instructions, that, when executed by digital processor(s) 304, cause quantum processor 308 to generate and return a plurality of samples.

Quantum processor 308 includes at least a plurality of qubits 312. In some implementations, plurality of qubits 312 may include qubits such as qubits 201, 202 of the quantum processor provided at least in part by circuit 200 of FIG. 2. Plurality of qubits 312 can be superconducting qubits, such as superconducting flux qubits or superconducting charge qubits. Qubits of plurality of qubits 312 can be magnetically, galvanically, or capacitively coupled to one another by couplers, such as coupler 210 of circuit 200.

Quantum computer 306 can include readout circuitry and/or structures for measuring the states of qubits in plurality of qubits 312. For example, to perform sampling, a state of each qubit in plurality of qubits 312 may be obtained from quantum processor 308 and transmitted to digital computer 302. In some implementations, measured states of the qubits in plurality of qubits 312 can be provided directly to MIP solver 310 for use in hybrid mixed integer problem solving, as described herein. In some implementations, the measured states of the qubits of plurality of qubits 312 can be stored in a memory, including one of: a memory of digital computer 302, such as system memory 122 of digital computer 102; a memory arranged as part of MIP solver 310; a memory device, such as shift register, in quantum processor 308; and, a memory located externally to system 300, which is communicatively coupled with quantum computer 306 and digital computer 302.

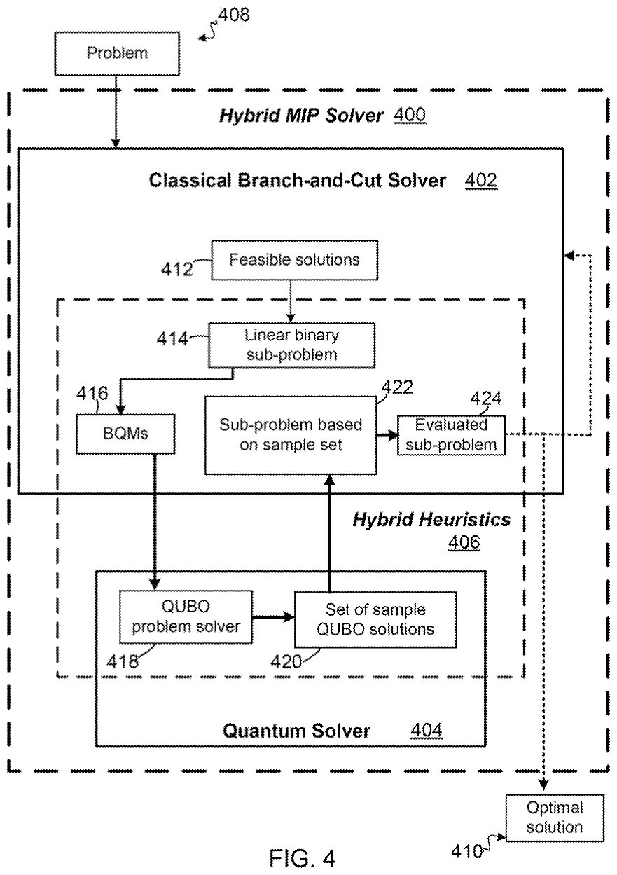

FIG. 4 illustrates a hybrid mixed integer problem (MIP) solver 400, in accordance with the presently described systems, devices, articles, and methods. In some implementations, hybrid MIP solver 400 can describe quantum-assisted MIP solution determination performed by both digital computer 102 and quantum computer 104 of computing system 100. In some implementations, hybrid MIP solver 400 can be implemented by digital computer 302 in communication with quantum computer 306 of system 300. More particularly, hybrid MIP solver 400 can illustrate an example of a portion of the data flow within and between MIP solver 310 and quantum processor 308.

Hybrid MIP solver 400 includes a classical branch-and-cut solver 402 in communication with a quantum solver 404. In some implementations, classical branch-and-cut solver 402 can be implemented by MIP solver 310 by at least one digital processor(s) 304 in FIG. 3. In some implementations, operations of quantum solver 404 can be implemented by at least one quantum processor 308, and instructions to perform these operations may be stored as part of MIP solver 310.

Based on a problem 408 that may take the form of a given MIP or a constrained optimization problem input to classical branch-and-cut solver 402, hybrid MIP solver 400 can determine an optimal solution 410 to the MIP through a combination of classical branch-and-cut solver 402 and quantum solver 404. Problem 408 includes an objective function and may include one or more constraint functions defining constraints on the outcomes of the variables of the MIP.

Classical branch-and-cut solver 402 can systematically determine candidate solutions of an MIP by: performing a state space search on a full set tree, bounding the search space based on estimated bounds on the optimal solution, and adding cutting planes to linear programming relaxations where appropriate. Classical branch-and-cut solver 402 can perform solver operations including: pre-solving, node selection, pricing, and cut generation.

Classical branch-and-cut solver 402 first evaluates the MIP as a first candidate solution (i.e., the entire state space of the problem and the first node of a tree). Classical branch-and-cut solver 402 uses a branch-and-bound algorithm to relax the MIP to generate the first node of the tree, then adds constraints on problem variables according to solutions of integer variables to generate branches of the tree. Classical branch-and-cut solver 402 adds additional constraints, such as Gomory cuts and knapsack cuts, to the relaxed MIP or a relaxed sub-problem of the MIP to reduce the search space of the solution. Classical branch-and-cut solver 402 enumerates and tests candidate solutions that branch off previously tested candidate solutions (i.e., searching a smaller state space of the MIP based on exhaustive exploration) until hybrid MIP solver 400 determines two or more feasible solutions 412.

In order to find an optimal solution to the MIP more quickly and accurately than a solution determined by purely classical computation, conventional enumerative processes of classical branch-and-cut solver 402 can be supplemented with hybrid heuristics 406. Operations of hybrid heuristics 406 can be carried out as part of classical branch-and-cut solver 402 by a digital processor and as part of quantum solver 404 by a quantum processor. While hybrid heuristics 406 can encompass the operations performed to produce linear binary sub-problems 414 and BQMs 416, as part of QUBO problem solver 418, and to produce set of sample QUBO solutions 420, sub-problem based on sample set 422, and evaluated sub-problem 424, classical branch-and-cut solver performs the operations to produce linear binary sub-problems 414, BQMs 416, sub-problem based on sample set 422, and evaluated sub-problem 424 and quantum solver performs the operations of QUBO problem solver 418 and operations to produce set of sample QUBO solutions 420.

During the iterative processes performed by classical branch-and-cut solver 402, hybrid heuristics 406 are employed. In some implementations, hybrid heuristics 406 can include one of a quantum-assisted crossover or a quantum-assisted mutation heuristic. Both quantum-assisted crossover and quantum-assisted mutation heuristics are improvement heuristics, which seek to find an improved solution based on one or more given feasible solutions 412. In these improvement heuristics, one or more sub-problems can be determined by addition of at least one constraint to the initial MIP through the fixing of variables to reduce a search for optimal solution 410 to a smaller neighborhood of the MIP state space.

All or a portion of the problem space can be broken down into one or more sub-problems to create a linear binary sub-problem 414 from two or more feasible solutions 412 found by classical branch-and-cut solver 402. Linear binary sub-problem 414 may also be referred to herein as a “first sub-problem” generated by hybrid MIP solver 400. Details describing creation of linear binary sub-problem 414 are described later herein with respect to methods 500 and 600.

Binary quadratic models (BQMs) 416 are cast from linear binary sub-problem 414 by classical branch-and-cut solver 402. BQMs 416 are models that are unconstrained and include only binary variables, and can encode an Ising and/or a quadratic unconstrained binary optimization (QUBO) model. In some implementations, BQMs 416 may be several disconnected BQMs, as determined by the particular operations performed to create linear binary sub-problem 414. In implementations in which hybrid MIP solver 400 is implemented on system 300, digital processor(s) 304 can be used to prepare a BQM representation of the first sub-problem in which the problem variables and the relationships between the problem variables are expressed as binary variables in only linear and quadratic terms.

In implementations in which hybrid MIP solver is implemented by computing system 100, digital processor(s) 106 of digital computer 102 is used to cast the first sub-problem as BQMs.

BQMs 416 cast by classical branch-and-cut solver 402 are solved by a QUBO problem solver 418 as part of quantum solver 404.

In hybrid MIP solver 400, the one or more of BQMs 416 can be represented as QUBOs, which in turn can be represented as a problem graph (also referred to as a “target graph” or a “topological representation”). The problem graph (or a “topological representation”) may be an arrangement of logical qubits that describes relationships between problem variables in a straightforward manner. Here, the problem graph is a graph that includes a collection of nodes and edges representing the relationships between variables of BQMs 416. The nodes represent variables in the problem graph q and the edges represent quadratic coefficients in the problem graph bij of equation (2).

A physical representation of BQMs 416 can be embedded onto a quantum processor through a mapping of the problem graph onto a hardware graph of the quantum processor. For the embedding of the problem graph of the QUBOs onto the quantum processor: nodes of the problem graph are mapped to qubits of the quantum processor, such as qubits 201, 202 of FIG. 2; and, edges are mapped to couplers of the quantum processor, such as coupler 210 of FIG. 2.

The hardware graph of the quantum processor is limited by a topology of qubits in the quantum processor. As such, representations of particular problems might not be trivial to map or embed onto a fixed topology of a quantum processor. For instance, since topologies of quantum processor might not be fully connected, some physical qubits might not be in direct communication with other physical qubits. As such, there are some instances where a problem having variables that are each represented by physical qubits cannot accurately express the relationships between all of the variables.

In some implementations, mapping the problem graph that represents BQMs 416 as QUBOs to the quantum processor requires mapping at least one of the logical qubits to a chain. A chain includes at least two physical qubits having a same state within the quantum processor, and a respective coupler to communicatively couple each pair of adjacent physical qubits. A chain of physical qubits may be used to represent one logical qubit, such that all connections between logical qubits in the topological representation are provided within the quantum processor. Herein, use of the term: “qubit” refers to a physical qubit within a quantum processor, unless explicitly specified otherwise.

Given the generally fixed topology and/or fixed connectivity of hardware of a quantum processor, some classes of problem may require use of embedding techniques. Examples of embedding techniques are described in U.S. Pat. Nos. 7,984,012 and 8,244,662; and in U.S. Patent Publication 2014/0250288 (granted as U.S. Pat. No. 9,501,747).

A QUBO representation of BQMs 416 can be embedded onto a quantum processor, such as quantum processor 126 or 308, and the quantum processor can perform quantum computation. In some implementations, this can include performance of quantum annealing to induce a change in state of qubits in the quantum processor. In some implementations, the quantum computation includes generation of sample solutions to the QUBO problems.

Hybrid MIP solver 400 can cause QUBO problem solver 418 to find a plurality of solutions to the problem represented as BQMs 416. Each generated solution is a sample solution to BQMs 416 that is represented by a plurality of binary variables. Collectively, these sample solutions obtained using quantum solver 404 is a set of sample QUBO solutions 420.

In implementations in which hybrid MIP solver 400 is implemented on system 300, digital processor(s) 304 of digital computer 302 transmits instructions to quantum processor 308 of quantum computer 306. These instructions encode the BQMs as QUBO models to embed the problem graph thereof onto quantum processor 308 using at least plurality of qubits 312. A sample solution is obtained when quantum computer 306 is instructed to solve the QUBO problem, such as through performance of quantum annealing. A set of sample solutions can be obtained by execution of quantum processor(s) 308 to solve a plurality of instances of the QUBO problem to obtain a plurality of solutions, each represented by states of plurality of qubits 312.

In implementations in which hybrid MIP solver 400 is implemented by computing system 100, the BQMs are embedded onto quantum processor 126 of quantum computer 104 as a QUBO problem, and digital processor(s) 106 of digital computer 102 instructs quantum processor 126 to solve the QUBO problem a predetermined or otherwise specified number of times to obtain samples. Samples may be transmitted back to digital computer 102 via readout control system 128 of quantum computer 104.

Set of sample QUBO solutions 420 obtained by quantum solver 404 can be used by classical-branch-and-cut solver 402 to further reduce a size of the search neighborhood of the MIP state space through the use of hybrid heuristics 406. To do so, classical branch-and-cut solver 402 can perform operations to identify same-valued variables throughout set of sample QUBO solutions 420 in order to create a sub-problem based on sample set 422. Hereinafter, the sub-problem based on sample set 422 may also be referred to as a “second sub-problem” generated by hybrid MIP solver 400. Since the QUBO solutions are obtained via execution of quantum solver 404 that only natively realizes binary variables, it follows that variables of QUBO solutions are all binary variables.

Sub-problem based on sample set 422 is solved by classical-branch-and-cut solver 402 to determine an evaluated sub-problem 424. Evaluated sub-problem 424 includes a solution to undetermined variables of sub-problem based on sample set 422, and thus the MIP, through use of branch, bound, and cut operations of classical-branch-and-cut solver 402. Use of classical branch-and-bound solver 402 to evaluate sub-problem based on sample set 422 is less computationally expensive than evaluation of a selected sub-problem of the MIP without use of hybrid heuristics 406, as a quantum processor can solve QUBOs more efficiently than a digital processor.

Evaluated sub-problem 424 comprises an evaluated value of the objective function of problem 408, which is compared to a value of the objective function of the incumbent solution. If evaluated sub-problem 424 comprises a value of the objective function that is better than that of the incumbent solution, then evaluated sub-problem 424 replaces the incumbent solution. Alternatively, if it is determined that the value of the objective function of evaluated sub-problem 424 is not better than that of the incumbent solution, then classical branch-and-cut solver 402 iterates to explore a different portion of the MIP state space. The incumbent solution is output as optimal solution 410 when all solutions have been evaluated by hybrid MIP solver 400.

Classical branch-and-bound solver 402 ceases to perform operations once one or more exit criteria is met. For example, exit criteria may be a computational time limit, or a difference between higher and lower bounds of a solution to the MIP.

Operations of hybrid MIP solver 400 can be described as a process performed by a hybrid computing system, such as computing system 100 or system 300.

The quantum-assisted crossover heuristic provides an improved solution based on two or more solutions within an existing solution pool. Problem variables of the two or more solutions that have identical values are fixed, thereby greatly reducing the search space based on previously successful solutions.

The operations performed as part of hybrid heuristics 406 are dependent on a selected hybrid heuristic, such as a quantum-assisted crossover heuristic or a quantum-assisted mutation heuristic, as discussed in further detail below. Both crossover and mutation heuristics are large neighborhood search heuristics, which seek to improve an incumbent solution of an MIP through the solution of significantly smaller sub-problems of the MIP that have search spaces containing high-quality feasible solutions.

In some implementations, operations of the quantum-assisted crossover heuristic are performed as hybrid heuristics 406. This is a quantum-enhanced variant of the classical crossover heuristic, which provides a new solution based on shared parameters of two or more previously determined solutions to the MIP. Values of problem variables of the two or more previously determined solutions that have a same value are fixed, and are used as constraints to reduce a solution search space. The two or more previously determined solutions are discretized to generate linear binary sub-problem 414, which can then be cast as BQMs 416 to be solved by QUBO problem solver 418. Further operations on set of sample QUBO solutions 420, sample set 422 and evaluated sub-problem 424 determine values of the unfixed problem variables to determine a solution to the MIP and complete operations of the quantum-assisted crossover heuristic.

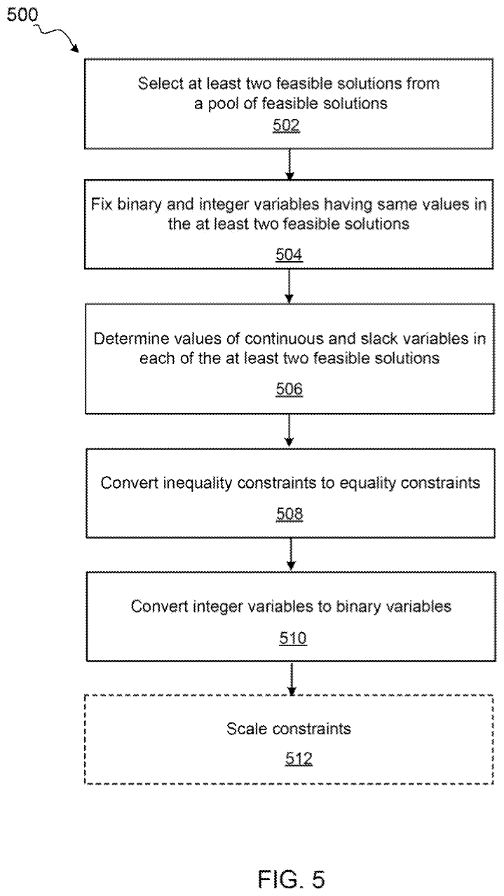

FIG. 5 illustrates method 500 to generate a first sub-problem as part of a quantum-assisted crossover heuristic. Method 500 includes acts 502 to 510, and optionally act 512, which can be performed by classical branch-and-cut solver 402 to generate linear binary sub-problem 414 of FIG. 4.

Method 500 can be performed by a digital computer, such as digital computer 102 or 302, in communication with a quantum computer, such as quantum computer 104 or 306. In some implementations, method 500 can be performed by hybrid MIP solver 400, at least a portion of which can be implemented by MIP solver 310.

At 502, at least two feasible solutions are selected from a pool of feasible solutions. In some implementations, the at least two feasible solutions may be randomly selected from the pool of feasible solutions. Alternatively, the at least two feasible solutions may be selected from the pool of feasible solutions based on determined or specified criteria, such as the quality of solution and/or diversity between the two or more solutions. In implementations in which method 500 is implemented by hybrid MIP solver 400, the at least two feasible solutions can be selected from feasible solutions 412 determined within classical branch-and-cut solver 402.

At 504, binary and integer variables that have same values across the at least two feasible solutions are fixed.

At 506, values of continuous variables in each of the at least two feasible solutions are determined. In implementations in which the at least two feasible solutions include slack variables, values of the slack variables are also determined. In some implementations, these values are calculated by the host solver, such as classical branch-and-cut solver 402 of hybrid MIP solver 400. In an alternative implementation, the values of the continuous and slack variables may be calculated algebraically.

At 508, inequality constraints are converted to equality constraints. To do so, the values of continuous and slack variables that have been determined at act 506 are fixed. In implementations in which method 500 is implemented by hybrid MIP solver 400, classical branch-and-cut solver 402 performs constraint conversion.

At 510, integer variables are converted into binary variables.

At 512, constraints are optionally scaled to have similar relative importance.

Following act 510 or, if performed, act 512, method 500 is complete and the resultant first sub-problem of the MIP has been generated according to the quantum-assisted cross-over heuristic. In implementations in which method 500 is the heuristic-specific process performed to generate linear binary sub-problem 414, after completion of method 500, hybrid MIP solver 400 can cast linear binary sub-problem 414 as BQMs 416 to be embedded onto a quantum processor and solved by QUBO problem solver 418.

In other implementations, operations of the quantum-assisted mutation heuristic are performed as hybrid heuristics 406. This is a quantum-enhanced variant of the classical mutation heuristic, which provides a new solution based on: fixing a random subset of problem variable values of a previously determined solution to the MIP for use as constraints to reduce a solution search space, and solving for values of the remaining unfixed problem variables. After fixing the random subset of problem variable values, the previously determined solution is discretized to generate linear binary sub-problem 414, which can then be cast as BQMs 416 to be solved by QUBO problem solver 418. Further operations on set of sample QUBO solutions 420, sample set 422 and evaluated sub-problem 424 determine the values of the unfixed problem variables to find a solution to the MIP and complete operations of the quantum-assisted mutation heuristic.

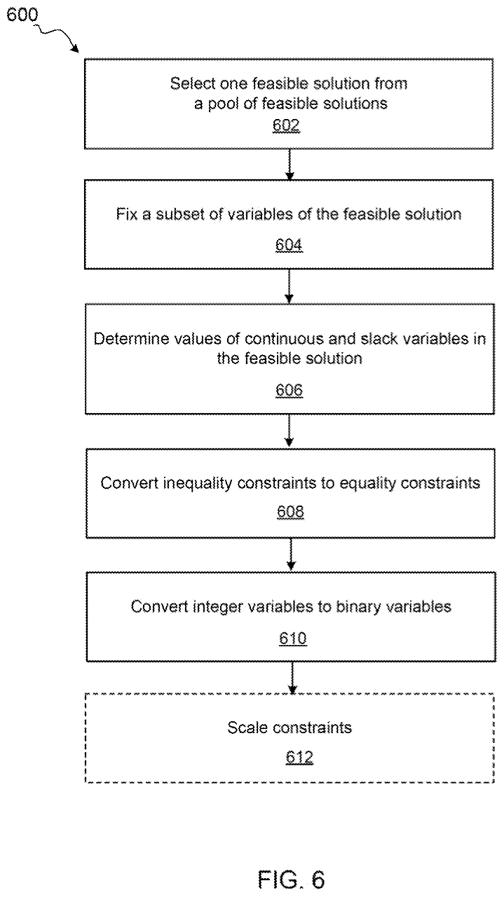

FIG. 6 illustrates method 600 to generate a first sub-problem as part of a quantum-assisted mutation heuristic. Method 600 includes acts 602 to 610, and optionally act 612, which can be performed by classical branch-and-cut solver 402 to generate linear binary sub-problem 414.

Method 600 can be performed by a digital computer, such as digital computer 102 or 302, in communication with a quantum computer, such as quantum computer 104 or 306. In some implementations, method 600 can be performed by hybrid MIP solver 400, at least a portion of which can be implemented by MIP solver 310.

At 602, one feasible solution is selected from a pool of feasible solutions. In some implementations, the one feasible solution may be randomly selected from the pool of feasible solutions. Alternatively, the one feasible solution may be selected from the pool of feasible solutions based on determined or specified criteria, such as solution quality. In implementations in which method 600 is implemented by hybrid MIP solver 400, the feasible solution can be selected from feasible solutions 412 determined within classical branch-and-cut solver 402.

At 604, values of a subset of variables of the selected feasible solution are fixed. Variables within the subset of variables include a portion of the binary and/or integer variables of the MIP.

At 606, values of continuous variables of the selected feasible solution are determined. If necessary, values of slack variables are also determined. In some implementations, these values can be calculated by the host solver, such as classical branch-and-cut solver 402 of hybrid MIP solver 400. In an alternative implementation, the values of the continuous and slack variables may be calculated algebraically.

At 608, inequality constraints are converted to equality constraints. To do so, the values of continuous and slack variables that have been determined at act 606 are fixed. In implementations in which method 600 is implemented by hybrid MIP solver 400, classical branch-and-cut solver 402 performs constraint conversion.

At 610, integer variables are converted into binary variables.

At 612, constraints are optionally scaled to have similar relative importance.

Following act 610, or, if performed, 612, method 600 is complete and the resultant first sub-problem of the MIP has been generated using the quantum-assisted mutation heuristic. In implementations in which method 600 is the heuristic-specific process performed to generate linear binary sub-problem 414, after completion of method 600, hybrid MIP solver 400 can cast linear binary sub-problem 414 as BQMs 416 to be embedded onto a quantum processor and solved by QUBO problem solver 418.

### Methods

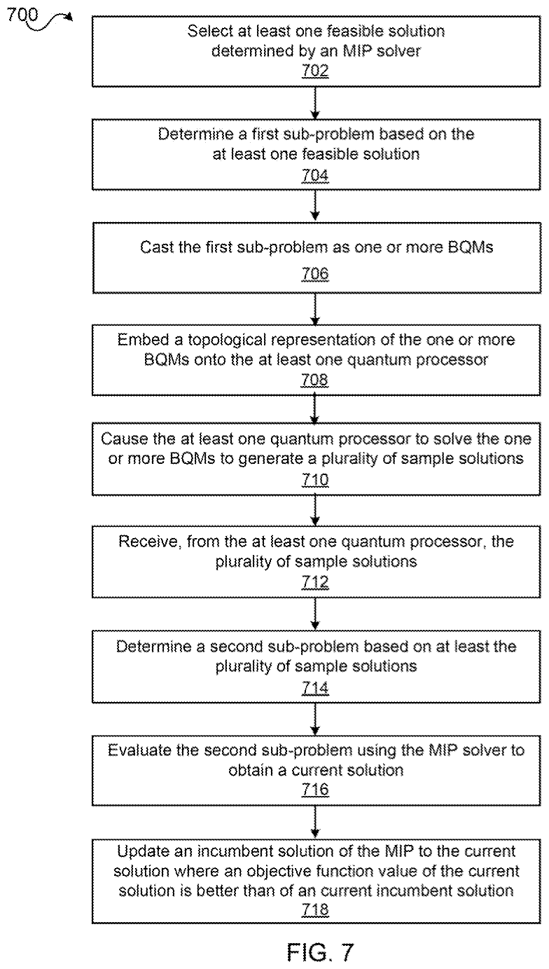

FIG. 7 illustrates a method 700 to determine an improved solution to a Mixed Integer Problem (MIP), in accordance with the present systems, devices, and methods. Method 700 is performed by at least one digital processor in communication with at least one quantum processor. To perform method 700, the digital processor may provide control signals or instructions to the quantum processor to complete specified method acts.

In at least some implementations, method 700 may be executed on a hybrid computing system comprising at least one digital processor in communication with at least one quantum processor, such as computing system 100 of FIG. 1 including digital computer 102, digital processor(s) 106, and quantum processor 126 or the quantum processor comprising circuit 200 of FIG. 2.

In some implementations, method 700 can be carried out by system 300 of FIG. 3 via digital computer 302 having at least one digital processor 304, which is in communication with quantum computer 306 that includes at least one quantum processor 308.

The MIP comprises a plurality of problem variables. The plurality of problem variables includes: one or more of: at least one integer variable and at least one binary variable, and one or more of: at least one continuous variable and at least one slack variable.

Method 700 comprises acts 702 to 718; however, a person skilled in the art will understand that the number of acts illustrated is an example, and, in some implementations, certain acts may be omitted, further acts may be added, and/or the order of the acts may be changed.

Prior to act 702, method 700 may be initiated as part of an MIP solver based on a specific predetermined or otherwise specified criterion. For instance, method 700 may be initiated by the MIP solver when one or more feasible solutions to the MIP have been obtained by the MIP solver. In alternative implementations, 700 may be initiated, for example, by a call from another program, a machine learning model, or directly by a user.

At 702, the at least one digital processor selects at least one feasible solution determined by an MIP solver.

In some implementations, digital computer 302 comprises MIP solver 310 including computer-readable and/or processor-executable instructions, that when executed by digital processor(s) 304, can perform operations of, for example, a branch-and-cut solver. In some implementations, MIP solver 310 executes hybrid MIP solver 400 of FIG. 4, including classical branch-and-cut solver 402. Classical branch-and-cut solver 402 may perform an enumerated search of a state space of a given MIP until at least two feasible solutions (i.e., at least two solutions of feasible solutions 412) have been found.

In some implementations, MIP solver 310 and/or classical branch-and-cut solver 402 can be used to find at least two feasible solutions to the MIP. Subsequent to a determination that there are at least two feasible solutions in a pool of feasible solutions (i.e., feasible solutions 412), at least one of the feasible solutions can be selected by digital processor(s) 304 according to act 502 of method 500 or act 602 of method 600, via the execution of computer-readable and/or processor-executable instructions stored as part of MIP solver 310.

In implementations in which the selected hybrid heuristic is the quantum-assisted crossover heuristic, two or more feasible solutions are selected from the pool of feasible solutions, such as in act 502 of method 500 (FIG. 5). In implementations in which the selected hybrid heuristic is the quantum-assisted mutation heuristic, one feasible solution is selected from a pool of feasible solutions, such as in act 602 of method 600 (FIG. 6). For both the quantum-assisted crossover and quantum-assisted mutation heuristics, the at least one feasible solution can optionally be selected randomly from the pool of feasible solutions. Alternatively, the at least one feasible solution can optionally be selected based on at least one predetermined or otherwise specified criterion, such as solution quality and/or solution diversity.

At 704, the at least one digital processor determines a first sub-problem of the MIP based on the at least one feasible solution. The first sub-problem of the MIP is a linear binary sub-problem. Determination of a first sub-problem of the MIP reduces the search area of the state space to find the optimal solution to the MIP. All variables of the first sub-problem have values restricted to either “0” or “1”. Bounded integer variables of the first sub-problem are expressed as a combination of binary variables.

In some implementations, MIP solver 310 may include stored computer-readable and/or processor-executable instructions, that when executed by digital processor(s) 304, cause digital processor(s) 304 to perform operations to determine a first sub-problem of the MIP. In some implementations, MIP solver 310 generates linear binary sub-problem 414 via classical branch-and-cut solver 402 of hybrid MIP solver 400. The first sub-problem can be generated by digital processor(s) 304, via the execution of computer-readable and/or processor-executable instructions stored as part of MIP solver 310.

Generation of the first sub-problem can be performed in a manner specific to the selected hybrid heuristic. Both the quantum-assisted crossover and quantum-assisted mutations heuristics include fixing a first plurality of problem variables of the MIP to generate the first sub-problem.

The quantum-assisted crossover heuristic includes relaxation of variables with identical values in different feasible solutions. In implementations in which hybrid MIP solver 400 uses the quantum-assisted crossover heuristic, digital processor(s) 304 generates a first sub-problem of the MIP according to acts 502 to 510, and optionally act 512, of method 500 (FIG. 5). This can include: fixing linear and binary problem variables that have a same value in all of the two or more feasible solutions of the MIP that were selected at act 702; use of MIP solver 310 to determine values of continuous and slack variables of the two or more selected feasible solutions of the MIP; fixing the values of the continuous and slack variables based on conversion of constraints; conversion of integer variables to binary variables; and, scaling of constraints.

The quantum-assisted mutation heuristic generates new solutions to an MIP by fixing a fraction of the integer and/or binary variables of a previously determined feasible solution, and determination of the values of the unfixed problem variables. In implementations in which hybrid MIP solver 400 uses the quantum-assisted mutation heuristic, digital processor(s) 304 generates a first sub-problem of the MIP according to acts 602 to 610, and optionally act 612, of method 600 (FIG. 6). This includes: fixing a subset of the binary and/or integer variables of the feasible solution selected at act 702; use of MIP solver 310 to determine values of continuous and slack variables of the selected feasible solution; fixing the values of the continuous and slack variables based on conversion of constraints; conversion of integer variables to binary variables; and scaling of constraints.

At 706, the at least one digital processor casts the first sub-problem as one or more Binary Quadratic Models (BQMs).

In some implementations, digital processor(s) 304 of digital computer 302 can cast the first sub-problem of the MIP as one or more BQMs, which encode a representation of the first sub-problem as Ising or QUBO models. In implementations in which system 300 performs operation of hybrid MIP solver 400, BQMs 416 are cast based on linear binary sub-problem 414 as part of execution of classical branch-and-cut solver 402.

At 708, a topological representation of the one or more BQMs is embedded onto the at least one quantum processor. In order to determine solutions to the first sub-problem of the MIP through the at least one quantum processor, the linear binary sub-problem is reconfigured into a form that is solvable based on the physical topology of said at least one quantum processor. First, the first sub-problem is cast as BQMs (act 706), and the BQMs are encoded as a graph of QUBOs or Ising models as a topological representation. Then, a hardware graph of the problem is determined based on the topological representation, such that a representation of the first sub-problem of the MIP can be embedded onto the physical topology of the quantum processor for solving therewith.

In some implementations, a memory associated with a computing system that comprises the at least one digital processor and at least one quantum processor includes logic to map the BQMs corresponding to the first binary sub-problem of the MIP to a QUBO or Ising model-based topological representation thereof. As well, the memory includes logic to further map the topological representation to a hardware graph representative of the physical topology of the quantum processor.

In implementations in which hybrid MIP solver 400 is implemented by system 300, a memory, such as a memory associated with MIP solver 310, can include logic that, when executed by digital processor(s) 304 of digital computer 302, maps BQMs 416 to a problem graph represents relationships between variables of BQMs 416 as nodes and edges. The aforementioned memory can also include logic that, upon execution by digital processor(s) 304, maps the problem graph of BQMs 416 to a hardware graph of quantum processor(s) 308 of quantum computer 306. Digital processor(s) 304 can transmit signals that embed the QUBO or Ising model-based problem graph of BQMs 416 onto the topology of plurality of qubits 312 of quantum processor(s) 308. Herein, embedding of a topological representation of BQMs 416 includes mapping nodes of the problem graph to plurality of qubits 312 and edges of the problem graph to couplers of quantum processor(s) 308. At 710, the at least one digital processor causes the at least one quantum processor to generate a plurality of sample solutions to the one or more BQMs.

In some implementations, digital processor(s) 304 of digital computer 302 executes machine-readable and/or processor-executable instructions that causes quantum processor 308 of quantum computer 306 to solve the one or more BQMs, for example, through performance of quantum annealing. Each sample solution of the plurality of sample solutions is a set of states of plurality of qubits 312 of quantum processor 308, which represents a solution to all of the one or more BQMs. In some implementations, digital processor(s) 106 of digital computer 102 may send instructions to quantum processor 126 via controller 118 that initiates performance of quantum annealing.

In some implementations, determination of the plurality of sample solutions to the BQMs comprises execution of computer-readable and/or processor-executable instructions, that when executed by digital processor(s) 304, cause hybrid MIP solver 400 to cast BQMs 416 as a QUBO problem. Hybrid MIP solver 400 then uses QUBO problem solver 418 to solve a predetermined or otherwise specified number of problem instances of the QUBO problem. The solution of each problem instance is a unique sample solution. The solutions to all such problem instances are a set of sample QUBO solutions 420, which are the plurality of sample solutions generated by quantum processor 308 of BQMs 416 and ultimately of linear binary sub-problem 414 (i.e., the first sub-problem of the MIP).

At 712, the at least one digital processor receives the plurality of sample solutions to the one or more BQMs from the at least one quantum processor.

In some implementations, digital processor(s) 304 of digital computer 302 may transmit one or more signals to obtain state values of the qubits in the quantum processor, such as of plurality of qubits 312 in quantum processor 308 or qubits in quantum processor 126. The signals may be provided to readout control system 128, which may generate one or more control signals to readout devices for retrieval of state information from the qubits. In some implementations, readout devices may include readout devices 251 and 252 of FIG. 2. The state information from the qubits can be the plurality of sample solutions.

Reading out the sample solutions can be performing using any suitable method of reading out states of plurality of qubits 312.

In some implementations, measuring qubit states for the receiving of sample solutions at 712 can be performed by copying classical states of qubits across a qubit array for read out by readout devices coupled to perimeter qubits, in which states are read out from the exterior of the qubit array inwards. Classical states of interior qubits can be copied to adjacently coupled qubits based on ferromagnetic state copying or adiabatic state copying. Further detail on readout based on state copying can be found in U.S. Pat. No. 7,639,035.

In some implementations, measurement of qubit states for the receival of sample solutions at 712 can be performed by a superconducting shift register, which employs latch qubits as shift register stages that are communicatively coupled to respective qubits of plurality of qubits 312. Application of pulses to clock lines can load and latch binary representations of states of plurality of qubits 312 to communicatively coupled shift register stages, and shift the binary representations of the qubit states across shift register stages to be read out by a measurement device. Optionally, one or more mediating latch qubits can be arranged between each one of plurality of qubits 312 and a respectively coupled shift register stage. Further detail can be found in U.S. Pat. No. 8,169,231.

In other implementations, measurement of qubit states for the receival of sample solutions at 712 can be performed by: generation of multiple synchronized pulses from a plurality of pulse sources, which is described in International Patent Application No. PCT/US2022/081507 (published as International Patent Application Publication WO2023114811); or, use of projective source measurement, as described in U.S. Patent Application Publication No. 2021/0248506.

The readout system transmits the sample solutions (i.e., the states of the qubits) to the digital computer. In some implementations, states of plurality of qubits 312 are read out, transmitted to digital computer 302, and may be stored as part of a memory in digital computer 302 or in communication with digital computer 302. In some implementations, the plurality of sample solutions may be stored in memory arranged as part of MIP solver 310. In some implementations, the plurality of sample solutions may be transmitted directly into MIP solver 310 and might not be preserved in memory.

At 714, the at least one digital processor determines a second sub-problem of the MIP based on at least the plurality of sample solutions to the one or more BQMs. The sample solutions were generated at act 710 based on a representation of the first sub-problem, in which a first subset of problem variables of the MIP was fixed to reduce the solution search neighborhood of the MIP state space. The second sub-problem is a singular problem determined based on the plurality of sample solutions to all of the BQMs cast to represent the singular first sub-problem. The second sub-problem is generated by fixing a second subset of problem variables, which are problem variables having a same value in each solution of the plurality of sample solutions to the BQMs. Through determination of the second sub-problem of the MIP, the solution search neighborhood of the MIP state space is further reduced.

In some implementations, MIP solver 310 may include stored computer-readable and/or processor-executable instructions, that when executed by digital processor(s) 304, performs operations to determine a second sub-problem of the MIP. In some implementations, MIP solver 310 generates sub-problem based on sample set 422 via classical branch-and-cut solver 402 of hybrid MIP solver 400. The second sub-problem can be generated by digital processor(s) 304 via the execution of computer-readable and/or processor-executable instructions stored as part of MIP solver 310.

At 716, the at least one digital processor evaluates the second sub-problem of the MIP using the MIP solver to obtain a current solution to the MIP. The MIP solver can be a branch-and-cut solver, and solving the second sub-problem can include systematically enumerating and testing all possible candidate solutions in the reduced solution search space until the solver finds the current solution. The evaluation of the second sub-problem can also include determination of a value of the objective function for the current solution. The reduction in the solution search neighborhood due to generation of the second sub-problem greatly reduces a computational complexity of determination of a current solution to the MIP, thereby also reducing computation time.

In some implementations, MIP solver 310 may include stored computer-readable and/or processor-executable instructions, that when executed by digital processor(s) 304, performs operations to evaluate the second sub-problem of the MIP. In some implementations, MIP solver 310 evaluates sub-problem based on sample set 422 to determine evaluated sub-problem 424 via classical branch-and-cut solver 402 of hybrid MIP solver 400. The second sub-problem can be solved by digital processor(s) 304 via the execution of computer-readable and/or processor-executable instructions stored as part of MIP solver 310. In some implementations, the determined current solution and its objective function value can be stored in a memory associated with MIP solver 310 or digital computer 302, such as system memory 122.

At 718, the at least one digital processor updates an incumbent solution to the MIP to the current solution where an objective function value of the current solution is determined to be an improvement over an objective function value of an existing incumbent solution.

In some implementations, MIP solver 310 may include stored computer-readable and/or processor-executable instructions, that when executed by digital processor(s) 304, compares an objective function value of the current solution to an objective function value of the current incumbent solution (i.e., the most optimal solution to the MIP prior to performance of the operations of method 700). Both the objective function values of the current solution and current incumbent solution can be stored in a memory associated with MIP solver 310, such as system memory 122. In some implementations, MIP solver 310 compares the objective function values via classical branch-and-cut solver 402 of hybrid MIP solver 400.

At act 718 of method 700, the determination of whether the objective function value of the current solution is an improvement over an objective function value of an existing incumbent solution can be the comparison of evaluated sub-problem 424 to the incumbent solution. If there is determined to be an improvement, digital processor(s) 304 updates the incumbent solution stored in memory associated with MIP solver 310, overwriting the current incumbent solution. Operations to update the current solution to the incumbent solution can be performed by digital processor(s) 304 via the execution of computer-readable and/or processor-executable instructions stored as part of MIP solver 310.

After 718, method 700 is terminated until, for example, it is called again.

### Post-Amble

The above described method(s), process(es), or technique(s) could be implemented by a series of processor readable instructions stored on one or more non-transitory processor-readable media. Some examples of the above described method(s), process(es), or technique(s) method are performed in part by a specialized device such as an adiabatic quantum computer or a quantum annealer or a system to program or otherwise control operation of an adiabatic quantum computer or a quantum annealer, for instance a computer that includes at least one digital processor. The above described method(s), process(es), or technique(s) may include various acts, though those of skill in the art will appreciate that in alternative examples certain acts may be omitted and/or additional acts may be added. Those of skill in the art will appreciate that the illustrated order of the acts is shown for example purposes only and may change in alternative examples. Some of the example acts or operations of the above described method(s), process(es), or technique(s) are performed iteratively. Some acts of the above described method(s), process(es), or technique(s) can be performed during each iteration, after a plurality of iterations, or at the end of all the iterations.

The above description of illustrated implementations, including what is described in the Abstract, is not intended to be exhaustive or to limit the implementations to the precise forms disclosed. Although specific implementations of and examples are described herein for illustrative purposes, various equivalent modifications can be made without departing from the spirit and scope of the disclosure, as will be recognized by those skilled in the relevant art. The teachings provided herein of the various implementations can be applied to other methods of quantum computation, not necessarily the example methods for quantum computation generally described above.

The various implementations described above can be combined to provide further implementations. All of the commonly assigned U.S. patent application publications, U.S. patent applications, foreign patents, and foreign patent applications referred to in this specification and/or listed in the Application Data Sheet are incorporated herein by reference, in their entirety, including but not limited to: U.S. Pat. Nos. 6,627,916; 7,135,701; 7,418,283; 7,533,068; 7,639,035; 7,984,012; 8,008,942; 8,169,231; 8,190,548; 8,195,596; 8,244,662; 8,421,053; 8,854,074; 9,424,526; 9,501,747; 10,938,346; and, 11,424,52; U.S. Patent Application Publications No. 2014/0250288; 2021/0248506 and 2022/0207404; U.S. Patent Application 63/462,356; and International Patent Application PCT/US2022/081507 (published as International Patent Application Publication WO2023114811).

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A method to determine an improved solution to a Mixed Integer Problem (MIP) having an objective function, the method performed by at least one digital processor in communication with at least one quantum processor and comprising:
selecting, by the at least one digital processor, at least one feasible solution determined by an MIP solver;
determining, by the at least one digital processor, a first sub-problem of the MIP based on the at least one feasible solution, wherein the first sub-problem is a linear binary sub-problem;
casting, by the at least one digital processor, the first sub-problem as one or more Binary Quadratic Models (BQMs);
embedding a topological representation of the one or more BQMs onto the at least one quantum processor;
causing, by the at least one digital processor, the at least one quantum processor to generate a plurality of sample solutions to the one or more BQMs;
receiving, from the at least one quantum processor, the plurality of sample solutions to the one or more BQMs;
determining, by the at least one digital processor, a second sub-problem of the MIP based on at least the plurality of sample solutions to the one or more BQMs;
evaluating, by the at least one digital processor, the second sub-problem of the MIP using the MIP solver to obtain a current solution to the MIP; and,
updating an incumbent solution of the MIP to the current solution where an objective function value of the current solution is determined to be an improvement over an objective function value of a current incumbent solution.

2. The method of claim 1, wherein:
the determining the first sub-problem of the MIP based on the at least one feasible solution comprises: fixing one or more first variables of the MIP, the one or more first variables of the MIP including one or more of: at least one binary variable and at least one integer variable; and,
the determining, by the at least one digital processor, the second sub-problem of the MIP based on at least the plurality of sample solutions to the one or more BQMs comprises: fixing one or more second variables of the MIP, wherein the one or more second variables are one or more binary variables having a same value across all sample solutions in the plurality of sample solutions to the one or more BQMs.

3. The method of claim 1, wherein prior to the selecting, by the at least one digital processor, the at least one feasible solution determined by the MIP solver, the method comprises: receiving, by the at least one digital processor, the objective function of the MIP; and, initializing one or more constraints of an optimal solution to the MIP.

4. The method of claim 1, wherein, prior to the selecting, by the at least one digital processor, at least one feasible solution determined by an MIP solver, the method comprises: iterating a Branch-and-Cut solver as the MIP solver over at least a portion of a problem state space to determine the at least one feasible solution.

5. The method of claim 1, wherein:
the selecting, by the at least one digital processor, at least one feasible solution determined by the MIP solver comprises: selecting two or more feasible solutions determined by the MIP solver; and,
the determining a first sub-problem of the MIP based on the at least one feasible solution comprises: fixing a first subset of problem variables of the MIP, wherein the first subset of problem variables of the MIP comprises at least one of binary variables and integer variables having a same value in all of the two or more feasible solutions.

6. The method of claim 5, wherein the determining a first sub-problem of the MIP based on the at least one feasible solution further comprises:
determining values of one or more of: at least one continuous variable and at least one slack variable in each of the two or more feasible solutions;
converting inequality constraints to equality constraints to fix the values of the one or more of: at least one continuous variable and at least one slack variable; and,
converting the integer variables to binary variables.

7. The method of claim 1, wherein:
the selecting, by the at least one digital processor, at least one feasible solution determined by the MIP solver comprises: selecting one feasible solution determined by the MIP solver; and,
the determining a first sub-problem of the MIP based on the at least one feasible solution comprises: fixing a random subset of problem variables of the MIP, the random subset of problem variables of the MIP comprising one or more of: at least one integer variable and at least one binary variable.

8. The method of claim 1, wherein the embedding a topological representation of the one or more BQMs onto the at least one quantum processor comprises:
mapping the one or more BQMs to the topological representation of the one or more BQMs that represent the first sub-problem of the MIP based on relationships between variables of the one or more BQMs;
mapping the topological representation of the one or more BQMs to a hardware graph corresponding to a topology of the at least one quantum processor; and,
embedding the first sub-problem of the MIP onto the at least one quantum processor in accordance with the hardware graph.

9. The method of claim 1, wherein the at least one quantum processor comprises a plurality of qubits, and wherein the causing the at least one quantum processor to generate the plurality of sample solutions to the one or more BQMs further comprises:
evolving, for predetermined or otherwise specified number of times, the plurality of qubits in the quantum processor having the topological representation of the one or more BQMs embedded thereon, wherein each sample solution of the plurality of sample solutions is characterized by states of the plurality of qubits after a respective evolution of the quantum processor.

10. The method of claim 1, wherein the determining, by the at least one digital processor, a first sub-problem of the MIP based on the at least one feasible solution comprises: performing operations of a crossover heuristic or operations of a mutation heuristic.

11. A system to determine an improved solution to a Mixed Integer Problem (MIP) having an objective function, the system comprising:
at least one non-transitory processor-readable media that stores at least one of processor-executable instructions or data; and,
at least one digital processor communicatively coupled to the least one non-transitory processor-readable media and to at least one quantum processor, and which, in response to execution of the at least one of processor-executable instructions or data, the at least one digital processor:
selects at least one feasible solution determined at least in part by an MIP solver;
determines a first sub-problem of the MIP based on the at least one feasible solution, wherein the first sub-problem is a linear binary sub-problem;
casts the first sub-problem as one or more Binary Quadratic Models (BQMs);
embeds a topological representation of the one or more BQMs onto the at least one quantum processor;
causes the at least one quantum processor to generate a plurality of sample solutions to the one or more BQMs;
receives, from the at least one quantum processor, the plurality of sample solutions to the one or more BQMs;
determines a second sub-problem of the MIP based on at least the plurality of sample solutions to the one or more BQMs;
evaluates the second sub-problem of the MIP using the MIP solver to obtain a current solution to the MIP; and,
updates an incumbent solution of the MIP to the current solution when an objective function value of the current solution is determined to be an improvement over an objective function value of a current incumbent solution.

12. The system of claim 11, wherein the at least one digital processor:
fixes one or more first variables of the MIP in order to determine the first sub-problem of the MIP based on the at least one feasible solution, wherein the one or more first variables of the MIP include one or more of: at least one binary variable and at least one integer variable; and,
fixes one or more second variables of the MIP in order to determine the second sub-problem based on at least the plurality of sample solutions, wherein the one or more second variables are one or more binary variables having a same value across all sample solutions in the plurality of sample solutions to the one or more BQMs.

13. The system of claim 11, wherein the MIP solver is a branch-and-cut solver or a branch-and-bound solver, and the at least one digital processor iterates the MIP solver over at least a portion of a problem state space to determine the at least one feasible solution.

14. The system of claim 11, wherein the at least one digital processor and the at least one quantum processor perform a quantum-assisted heuristic to determine the improved solution to the MIP.

15. The system of claim 14, wherein the quantum-assisted heuristic is a quantum-assisted crossover heuristic or a quantum-assisted mutation heuristic.

16. The system of claim 11, wherein the at least one quantum processor comprises a plurality of superconducting qubits.

17. The system of claim 16, wherein each sample solution of the plurality of sample solutions to the one or more BQMs is a set of states of the plurality of qubits obtained through a respective evolution of the plurality of qubits of the at least one quantum processor.

18. The system of claim 11, wherein the quantum processor is a quantum annealer or performs adiabatic quantum computation.

19. The system of claim 11, wherein the at least one digital processor:
selects two or more feasible solutions determined by the MIP solver; and,
fixes a first subset of problem variables of the MIP, wherein the first subset of problem variables of the MIP comprises one or more of: binary variables and integer variables having a same value in all of the two or more feasible solutions.

20. The system of claim 11, wherein the at least one digital processor:
selects one feasible solution determined by the MIP solver; and,
fixes a random subset of problem variables of the MIP comprising one or more of: at least one integer variable and at least one binary variable.
